(19) United States
(12) Patent Application Publication
(10) Pub. No.: US 2026/0065026 A1
(43) Pub. Date: Mar. 5, 2026

(54) NEURAL NETWORK BASED IMAGE AND VIDEO COMPRESSION METHOD WITH INTEGER OPERATIONS

(71) Applicants: Douyin Vision Co., Ltd., Beijing (CN); Bytedance Inc., Los Angeles, CA (US)

(72) Inventors: Semih Esenlik, San Diego, CA (US); Zhaobin Zhang, San Diego, CA (US); Yaojun Wu, Beijing (CN); Meng Wang, Beijing (CN); Kai Zhang, San Diego, CA (US); Li Zhang, San Diego, CA (US)

(21) Appl. No.: 19/251,212

(22) Filed: Jun. 26, 2025

Related U.S. Application Data
(63) Continuation of application No. PCT/CN2023/142897, filed on Dec. 28, 2023.

(30) Foreign Application Priority Data
Dec. 28, 2022 (WO) PCT/CN2022/142668

(51) Int. Cl. G06N 3/0464; G06N 3/048

(52) U.S. Cl. CPC G06N 3/0464; G06N 3/048

(57) ABSTRACT

A mechanism for processing video data is disclosed. A determination is made to apply a neural subnetwork to perform a convolution operation using only integer values. The neural subnetwork also performs an activation function on the output of the convolution operation using only integer values. A conversion is performed between a visual media data and a bitstream based on the convolution operation and the activation function.

### CROSS REFERENCE TO RELATED APPLICATIONS

This application is a continuation of International Patent Application No. PCT/CN2023/142897, filed on Dec. 28, 2023, which claims the priority to and benefits of International Patent Application No. PCT/CN2022/142668, filed on Dec. 28, 2022. All the aforementioned patent applications are hereby incorporated by reference in their entireties.

### TECHNICAL FIELD

The present disclosure relates to processing of digital images and video.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video or image data, comprising: applying a neural network to perform a convolution operation on an input and to perform an activation function on an output of the convolution operation, wherein the convolution operation and the activation function are performed using only integer values; and performing a conversion between visual media data and a bitstream based on the convolution operation and the activation function.

Optionally, in any of the preceding aspects, another implementation of the aspect provides that the input comprises only integer values.

Optionally, in any of the preceding aspects, another implementation of the aspect provides the convolution operation employs a kernel of integer weights and an integer bias, wherein the integer weights are elementwise multiplied with the input, and wherein the integer bias comprises all integer values.

Optionally, in any of the preceding aspects, another implementation of the aspect provides that a size of the kernel is 3×3.

Optionally, in any of the preceding aspects, another implementation of the aspect provides that the method is applicable to any convolution operation, regardless of dimension, the size of the kernel, and the integer bias.

Optionally, in any of the preceding aspects, another implementation of the aspect provides that the activation function employs bit-shifting.

Optionally, in any of the preceding aspects, another implementation of the aspect provides that non-integer values are disallowed for the convolution operation and for the activation function.

Optionally, in any of the preceding aspects, another implementation of the aspect provides that the convolution operation disallows non-integer values by employing only multiplications and additions using integer inputs.

Optionally, in any of the preceding aspects, another implementation of the aspect provides that the convolution operation is performed using only multiplication with integer values and addition with integer values.

Optionally, in any of the preceding aspects, another implementation of the aspect provides that the input comprises only integer values to ensure that an output of the neural network comprises only integer values.

Optionally, in any of the preceding aspects, another implementation of the aspect provides that the convolution operation is a two-dimensional convolution operation and performed according to:

$$result [ i , j ] = {\sum }_{m = - 1 , n = - 1}^{1 , 1} in [ i + m , j + n ] * kernel [ m , n ] + bias .$$

Optionally, in any of the preceding aspects, another implementation of the aspect provides that the activation function comprises a rectified linear unit (ReLU) or a quantized leaky ReLU.

Optionally, in any of the preceding aspects, another implementation of the aspect provides that the activation function does not use any division operation, any rounding operation, or any multiplication operation including a non-integer.

Optionally, in any of the preceding aspects, another implementation of the aspect provides that the activation function is performed according to one or combination of:

$$f ( x , n , A , B , C ) = \{ \begin{matrix}bitshift ( x , n ) & if x \geq 0 \\ - bitshift ( ( - x ) * A + B , n + C ) & if x < 0\end{matrix} ; or$$

$$f ( x , n , A , B , C ) = \{ \begin{matrix}floor ( \frac{x}{{2}^{n}} ) & if x \geq 0 \\ - floor ( \frac{( - x ) * A + B}{{2}^{n + C}} ) & if x < 0\end{matrix} ; or$$

$$f ( x , n , A , B , C ) = \{ \begin{matrix}floor ( bitshift ( x , n ) ) & if x \geq 0 \\ - floor ( bitshift ( ( - x ) * A + B , n + C ) ) & if x < 0\end{matrix} ; or$$

$$f ( x , n , A , B , C ) = \{ \begin{matrix}bitshift ( x + {2}^{n - 1} , n ) & if x \geq 0 \\ - bitshift ( ( - x ) * A + B , n + C ) & if x < 0\end{matrix} ; or$$

$$f ( x , n , A , B , C ) = \{ \begin{matrix}bitshift ( x , n ) & if x \geq 0 \\ - bitshift ( ( - x ) * A + B , n + C ) & if x < 0\end{matrix} ,$$

wherein the bitshift(x, n) operation corresponds to a bitwise shift operator.

Optionally, in any of the preceding aspects, another implementation of the aspect provides that a division operation followed by the floor( ) operation is implemented using the bitwise shift operator.

Optionally, in any of the preceding aspects, another implementation of the aspect provides that a division operation is replaced by a series of operations using at least one lookup table.

Optionally, in any of the preceding aspects, another implementation of the aspect provides that the activation function is performed according to:

$$f ( x , A , B , C ) = \{ \begin{matrix}x & if x \geq 0 \\ - floor ( \frac{( - x ) * A + B}{{2}^{C}} ) & if x < 0\end{matrix} ; or$$

$$f ( x , A , B , C ) = \{ \begin{matrix}x & if x \geq 0 \\ - bitshift ( ( - x ) * A + B , C ) & if x < 0\end{matrix} .$$

Optionally, in any of the preceding aspects, another implementation of the aspect provides that constants A, B, and C are integer numbers that approximate a regular leaky ReLU function.

Optionally, in any of the preceding aspects, another implementation of the aspect provides that constants A, B, and C are set to approximate a negative slope of the leaky ReLU function.

Optionally, in any of the preceding aspects, another implementation of the aspect provides that the constants A, B, and C are set to approximate an arbitrary negative slope of the leaky ReLU function, which is a floating point number between 0 and 1 or between 0 and −1.

Optionally, in any of the preceding aspects, another implementation of the aspect provides that the constant B has a value of zero when bit shifting is a left shift operation, and wherein the constant B has a value of one when the bit shifting is a right shift operation.

Optionally, in any of the preceding aspects, another implementation of the aspect provides that the activation function is performed according to:

$$f ( x , n , A , B , C ) = \{ \begin{matrix}bitshift ( x + D , n ) & if x \geq 0 \\ - bitshift ( ( - x ) * A + B , n + C ) & if x < 0\end{matrix} .$$

Optionally, in any of the preceding aspects, another implementation of the aspect provides that the input is bit shifted by n bits in both a positive branch and in a negative branch.

Optionally, in any of the preceding aspects, another implementation of the aspect provides that the convolution operation comprises a convolution layer with integer weights and bias values, and the activation function comprises a rectified linear unit (ReLU) function.

Optionally, in any of the preceding aspects, another implementation of the aspect provides that additional layers are included between the convolution operation and the activation function.

Optionally, in any of the preceding aspects, another implementation of the aspect provides that a bit shifting operation is performed after the convolution operation and before the activation function.

Optionally, in any of the preceding aspects, another implementation of the aspect provides that a negative slope of the activation function is equal to zero when the input is an integer value, and wherein an output is guaranteed to be an integer value.

Optionally, in any of the preceding aspects, another implementation of the aspect provides that the convolution operation comprises one or more of multiplication with integer, a bit shifting operation, addition with an integer, and clipping.

Optionally, in any of the preceding aspects, another implementation of the aspect provides that the method is performed without any division, multiplication or addition with a non-integer value, or rounding operation.

Optionally, in any of the preceding aspects, another implementation of the aspect provides that one of the additional layers is a cropping layer.

Optionally, in any of the preceding aspects, another implementation of the aspect provides that the additional layers do not include a device dependent operation using a floating point, division, or rounding.

Optionally, in any of the preceding aspects, another implementation of the aspect provides that the neural network is one of a plurality of neural subnetworks each containing a convolution operation and an activation function.

Optionally, in any of the preceding aspects, another implementation of the aspect provides that a quantization operation is performed on an output of the activation function, and wherein the quantization operation uses only integers.

Optionally, in any of the preceding aspects, another implementation of the aspect provides that the integers used for the quantization operation are obtained from a table comprising quantization levels and quantized output values.

Optionally, in any of the preceding aspects, another implementation of the aspect provides that the quantization operation comprises a mapping function between an integer input and an integer output.

Optionally, in any of the preceding aspects, another implementation of the aspect provides that the convolution operation and the activation function are incorporated in a hyper scale decoder module.

Optionally, in any of the preceding aspects, another implementation of the aspect provides that the output of the hyper scale decoder module comprises the probability parameters or a standard deviation.

Optionally, in any of the preceding aspects, another implementation of the aspect provides that one or more of the probability parameters comprise a standard deviation.

Optionally, in any of the preceding aspects, another implementation of the aspect provides that an output of the activation function is a reconstructed image.

Optionally, in any of the preceding aspects, another implementation of the aspect provides that the convolution operation and the activation function consist essentially of multiplication with integer values, bit-shifting operations, addition with integer values, clipping, and combinations thereof.

Optionally, in any of the preceding aspects, another implementation of the aspect provides that the conversion includes encoding the visual media data into the bitstream.

Optionally, in any of the preceding aspects, another implementation of the aspect provides that the conversion includes decoding the visual media data from the bitstream.

A second aspect relates to an apparatus for processing media data comprising: one or more processors; and a non-transitory memory with instructions thereon, wherein the instructions upon execution by the processor cause the apparatus to perform the method in any of the disclosed embodiments.

A third aspect relates to a non-transitory computer readable medium, comprising a computer program product for use by a video coding device, the computer program product comprising computer executable instructions stored on the non-transitory computer readable medium such that when executed by a processor cause the video coding device to perform the method in any of the disclosed embodiments.

A fourth aspect relates to a non-transitory computer-readable recording medium storing a bitstream of a video which is generated by a method performed by a video processing apparatus, wherein the method comprises the method in any of the disclosed embodiments.

A fifth aspect relates to a method for storing a bitstream of a video comprising the method in any of the disclosed embodiments.

A sixth aspect relates to a method, apparatus, or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram illustrating an example transform coding scheme.

FIG. 2 illustrates example latent representations of an image.

FIG. 3 is a schematic diagram illustrating an example autoencoder implementing a hyperprior model.

FIG. 4 is a schematic diagram illustrating an example combined model configured to jointly optimize a context model along with a hyperprior and the autoencoder.

FIG. 5 illustrates an example encoding process.

FIG. 6 illustrates an example decoding process.

FIG. 7 illustrates an example decoding process according to the present disclosure.

FIG. 8 illustrates an example learning-based image codec architecture.

FIG. 9 illustrates an example synthesis transform for learning based image coding.

FIG. 10 illustrates an example leaky rectified linear unit (ReLU) activation function.

FIG. 11 illustrates an example leaky ReLU activation function.

FIG. 12 illustrates an example basic unit according to disclosure.

FIG. 13 illustrates another example basic unit according to disclosure.

FIG. 14 illustrates another example basic unit according to disclosure.

FIG. 15 is a block diagram showing an example video processing system.

FIG. 16 is a block diagram of an example video processing apparatus.

FIG. 17 is a flowchart for an example method of video processing.

FIG. 18 is a block diagram that illustrates an example video coding system.

FIG. 19 is a block diagram that illustrates an example encoder.

FIG. 20 is a block diagram that illustrates an example decoder.

FIG. 21 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

### 1. Initial Discussion

The present disclosure is related to a neural network-based image and video compression approach using separate processing of color components of an image, wherein control parameters used for processing of one component is used also for the other component.

### 2. Further Discussion

Deep learning is developing in a variety of areas, such as in computer vision and image processing. Inspired by the successful application of deep learning technology to computer vision areas, neural image/video compression technologies are being studied for application to image/video compression techniques. The neural network is designed based on interdisciplinary research of neuroscience and mathematics. The neural network has shown strong capabilities in the context of non-linear transform and classification. An example neural network-based image compression algorithm achieves comparable rate-distortion (R-D) performance with Versatile Video Coding (VVC), which is a video coding standard developed by the Joint Video Experts Team (JVET) with experts from motion picture experts group (MPEG) and Video coding experts group (VCEG). Neural network-based video compression is an actively developing research area resulting in continuous improvement of the performance of neural image compression. However, neural network-based video coding is still a largely undeveloped discipline due to the inherent difficulty of the problems addressed by neural networks.

### 2.1 Image/Video Compression

Image/video compression usually refers to a computing technology that compresses video images into binary code to facilitate storage and transmission. The binary codes may or may not support losslessly reconstructing the original image/video. Coding without data loss is known as lossless compression and coding while allowing for targeted loss of data in known as lossy compression, respectively. Most coding systems employ lossy compression since lossless reconstruction is not necessary in most scenarios. Usually the performance of image/video compression algorithms is evaluated based on a resulting compression ratio and reconstruction quality. Compression ratio is directly related to the number of binary codes resulting from compression, with fewer binary codes resulting in better compression. Reconstruction quality is measured by comparing the reconstructed image/video with the original image/video, with greater similarity resulting in better reconstruction quality.

Image/video compression techniques can be divided into video coding methods and neural-network-based video compression methods. Video coding schemes adopt transform-based solutions, in which statistical dependency in latent variables, such as discrete cosine transform (DCT) and wavelet coefficients, is employed to carefully hand-engineer entropy codes to model the dependencies in the quantized regime. Neural network-based video compression can be grouped into neural network-based coding tools and end-to-end neural network-based video compression. The former is embedded into existing video codecs as coding tools and only serves as part of the framework, while the latter is a separate framework developed based on neural networks without depending on video codecs.

A series of video coding standards have been developed to accommodate the increasing demands of visual content transmission. The international organization for standardization (ISO)/International Electrotechnical Commission (IEC) has two expert groups, namely Joint Photographic Experts Group (JPEG) and Moving Picture Experts Group (MPEG). International Telecommunication Union (ITU) telecommunication standardization sector (ITU-T) also has a Video Coding Experts Group (VCEG), which is for standardization of image/video coding technology. The influential video coding standards published by these organizations include Joint Photographic Experts Group (JPEG), JPEG 2000, H.262, H.264/advanced video coding (AVC) and H.265/High Efficiency Video Coding (HEVC). The Joint Video Experts Team (JVET), formed by MPEG and VCEG, developed the Versatile Video Coding (VVC) standard. An average of 50% bitrate reduction is reported by VVC under the same visual quality compared with HEVC.

Neural network-based image/video compression/coding is also under development. Example neural network coding network architectures are relatively shallow, and the performance of such networks is not satisfactory. Neural network-based methods benefit from the abundance of data and the support of powerful computing resources, and are therefore better exploited in a variety of applications. Neural network-based image/video compression has shown promising improvements and is confirmed to be feasible. Nevertheless, this technology is far from mature and a lot of challenges should be addressed.

### 2.2 Neural Networks

Neural networks, also known as artificial neural networks (ANN), are computational models used in machine learning technology. Neural networks are usually composed of multiple processing layers, and each layer is composed of multiple simple but non-linear basic computational units. One benefit of such deep networks is a capacity for processing data with multiple levels of abstraction and converting data into different kinds of representations. Representations created by neural networks are not manually designed. Instead, the deep network including the processing layers is learned from massive data using a general machine learning procedure. Deep learning eliminates the necessity of handcrafted representations. Thus, deep learning is regarded useful especially for processing natively unstructured data, such as acoustic and visual signals. The processing of such data has been a longstanding difficulty in the artificial intelligence field.

### 2.3 Neural Networks For Image Compression

Neural networks for image compression can be classified in two categories, including pixel probability models and auto-encoder models. Pixel probability models employ a predictive coding strategy. Auto-encoder models employ a transform-based solution. Sometimes, these two methods are combined together.

### 2.3.1 Pixel Probability Modeling

According to Shannon's information theory, the optimal method for lossless coding can reach the minimal coding rate, which is denoted as −log₂ ρ(x) where ρ(x) is the probability of symbol x. Arithmetic coding is a lossless coding method that is believed to be among the optimal methods. Given a probability distribution ρ(x), arithmetic coding causes the coding rate to be as close as possible to a theoretical limit −log₂ρ(x) without considering the rounding error. Therefore, the remaining problem is to determine the probability, which is very challenging for natural image/video due to the curse of dimensionality. The curse of dimensionality refers to the problem that increasing dimensions causes data sets to become sparse, and hence rapidly increasing amounts of data is needed to effectively analyze and organize data as the number of dimensions increases.

Following the predictive coding strategy, one way to model ρ(x) is to predict pixel probabilities one by one in a raster scan order based on previous observations, where x is an image, can be expressed as follows:

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, estimation of the conditional probability can be difficult. Thereby, a simplified method is to limit the range of the context of the current pixel as follows:

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the red (R), green (G), and blue (B) (RGB) color component, the R sample is dependent on previously coded pixels (including R,G, and/or B samples), the current G sample may be coded according to previously coded pixels and the current R sample. Further, when coding the current B sample, the previously coded pixels and the current R and G samples may also be taken into consideration.

Neural networks may be designed for computer vision tasks, and may also be effective in regression and classification problems. Therefore, neural networks may be used to estimate the probability of ρ(xᵢ) given a context x₁, x₂, . . . , xᵢ₋₁.

Most of the methods directly model the probability distribution in the pixel domain. Some designs also model the probability distribution as conditional based upon explicit or latent representations. Such a model can be expressed as:

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and ρ(x)=p (h)ρ(x|h) indicates the modeling is split into an unconditional model and a conditional model. The additional condition can be image label information or high-level representations.

### 2.3.2 Auto-Encoder

An auto-encoder is now described. The auto-encoder is trained for dimensionality reduction and include an encoding component and a decoding component. The encoding component converts the high-dimension input signal to low-dimension representations. The low-dimension representations may have reduced spatial size, but a greater number of channels. The decoding component recovers the high-dimension input from the low-dimension representation. The auto-encoder enables automated learning of representations and eliminates the need of hand-crafted features, which is also believed to be one of the most important advantages of neural networks.

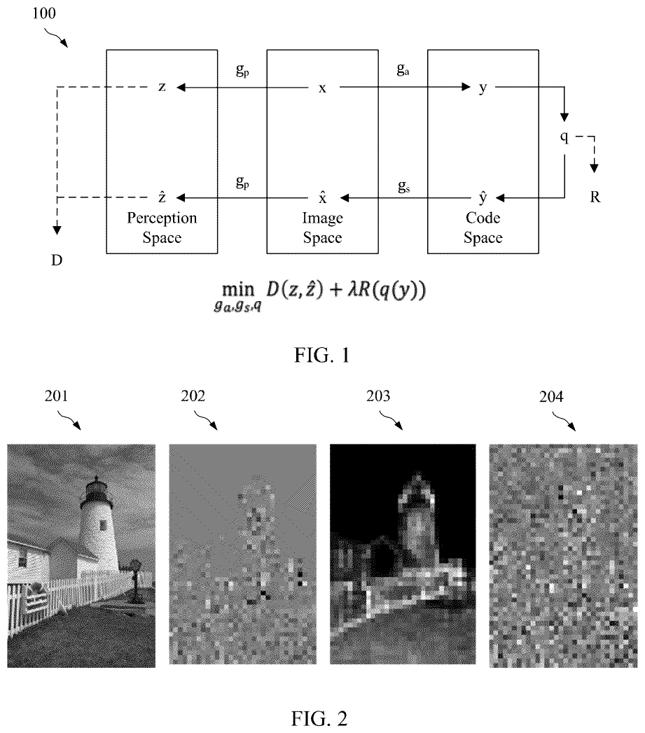

FIG. 1 is a schematic diagram illustrating an example transform coding scheme 100. The original image x is transformed by the analysis network g_{α} to achieve the latent representation y. The latent representation y is quantized (q) and compressed into bits. The number of bits R is used to measure the coding rate. The quantized latent representation \hat{γ} is then inversely transformed by a synthesis network gₛ to obtain the reconstructed image x. The distortion (D) is calculated in a perceptual space by transforming x and \hat{x} with the function g_{ρ}, resulting in z and \hat{z}, which are compared to obtain D.

An auto-encoder network can be applied to lossy image compression. The learned latent representation can be encoded from the well-trained neural networks. However, adapting the auto-encoder to image compression is not trivial since the original auto-encoder is not optimized for compression, and is thereby not efficient for direct use as a trained auto-encoder. In addition, other major challenges exist. First, the low-dimension representation should be quantized before being encoded. However, the quantization is not differentiable, which is required in backpropagation while training the neural networks. Second, the objective under a compression scenario is different since both the distortion and the rate need to be take into consideration. Estimating the rate is challenging. Third, a practical image coding scheme should support variable rate, scalability, encoding/decoding speed, and interoperability. In response to these challenges, various schemes are under development.

An example auto-encoder for image compression using the example transform coding scheme 100 can be regarded as a transform coding strategy. The original image x is transformed with the analysis network γ=g_{α} (x), where γ is the latent representation to be quantized and coded. The synthesis network inversely transforms the quantized latent representation ŷ back to obtain the reconstructed image \hat{x}=gₛ (ŷ). The framework is trained with the rate-distortion loss function [symbol] =D+λR, where D is the distortion between x and \hat{x}, R is the rate calculated or estimated from the quantized representation ŷ, and λ is the Lagrange multiplier. D can be calculated in either pixel domain or perceptual domain. Most example systems follow this prototype and the differences between such systems might only be the network structure or loss function.

### 2.3.3 Hyper Prior Model

FIG. 2 illustrates example latent representations of an image. FIG. 2 includes an image 201 from the Kodak dataset, visualization of the latent 202 representation y of the image 201, a standard deviations σ 203 of the latent 202, and latents y 204 after a hyper prior network is introduced. A hyper prior network includes a hyper encoder and decoder. In the transform coding approach to image compression, as shown in FIG. 1, the encoder subnetwork transforms the image vector x using a parametric analysis transform g_{α}(x, Ø_{g}) into a latent representation y, which is then quantized to form ŷ. Because ŷ is discrete-valued, y can be losslessly compressed using entropy coding techniques such as arithmetic coding and transmitted as a sequence of bits.

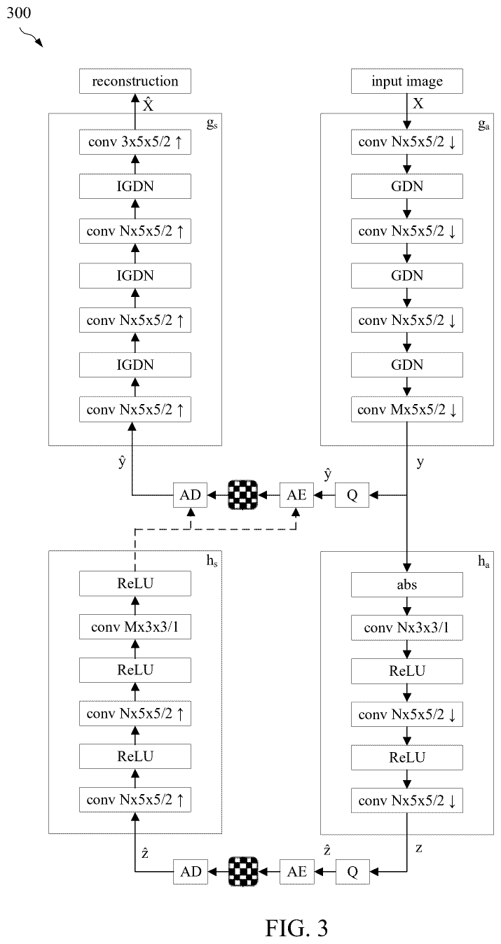

As evident from the latent 202 and the standard deviations σ 203 of FIG. 2, there are significant spatial dependencies among the elements of ŷ. Notably, their scales (standard deviations σ 203) appear to be coupled spatially. An additional set of random variables \hat{z} may be introduced to capture the spatial dependencies and to further reduce the redundancies. In this case the image compression network is depicted in FIG. 3.

FIG. 3 is a schematic diagram 300 illustrating an example network architecture of an autoencoder implementing a hyperprior model. The upper side shows an image autoencoder network, and the lower side corresponds to the hyperprior subnetwork. The analysis and synthesis transforms are denoted as g_{α} and g_{α}. Q represents quantization, and AE, AD represent arithmetic encoder and arithmetic decoder, respectively. The hyperprior model includes two subnetworks, hyper encoder (denoted with h_{α}) and hyper decoder (denoted with hₛ). The hyper prior model generates a quantized hyper latent (\hat{z}) which comprises information related to the probability distribution of the samples of the quantized latent ŷ. \hat{z} is included in the bitstream and transmitted to the receiver (decoder) along with ŷ.

In schematic diagram 300, the upper side of the models is the encoder g_{α} and decoder gₛ as discussed above. The lower side is the additional hyper encoder h_{α} and hyper decoder hₛ networks that are used to obtain \hat{z}. In this architecture the encoder subjects the input image x to g_{α}, yielding the responses y with spatially varying standard deviations. The responses y are fed into h_{α}, summarizing the distribution of standard deviations in z. z is then quantized (\hat{z}), compressed, and transmitted as side information. The encoder then uses the quantized vector \hat{z} to estimate σ, the spatial distribution of standard deviations, and uses σ to compress and transmit the quantized image representation ŷ. The decoder first recovers \hat{z} from the compressed signal. The decoder then uses hₛ to obtain σ, which provides the decoder with the correct probability estimates to successfully recover ŷ as well. The decoder then feeds ŷ into gₛ to obtain the reconstructed image.

When the hyper encoder and hyper decoder are added to the image compression network, the spatial redundancies of the quantized latent ŷ are reduced. The latents y 204 in FIG. 2 correspond to the quantized latent when the hyper encoder/decoder are used. Compared to the standard deviations σ 203, the spatial redundancies are significantly reduced as the samples of the quantized latent are less correlated.

### 2.3.4 Context Model

Although the hyper prior model improves the modelling of the probability distribution of the quantized latent ŷ, additional improvement can be obtained by utilizing an autoregressive model that predicts quantized latents from their causal context, which may be known as a context model.

The term auto-regressive indicates that the output of a process is later used as an input to the process. For example, the context model subnetwork generates one sample of a latent, which is later used as input to obtain the next sample.

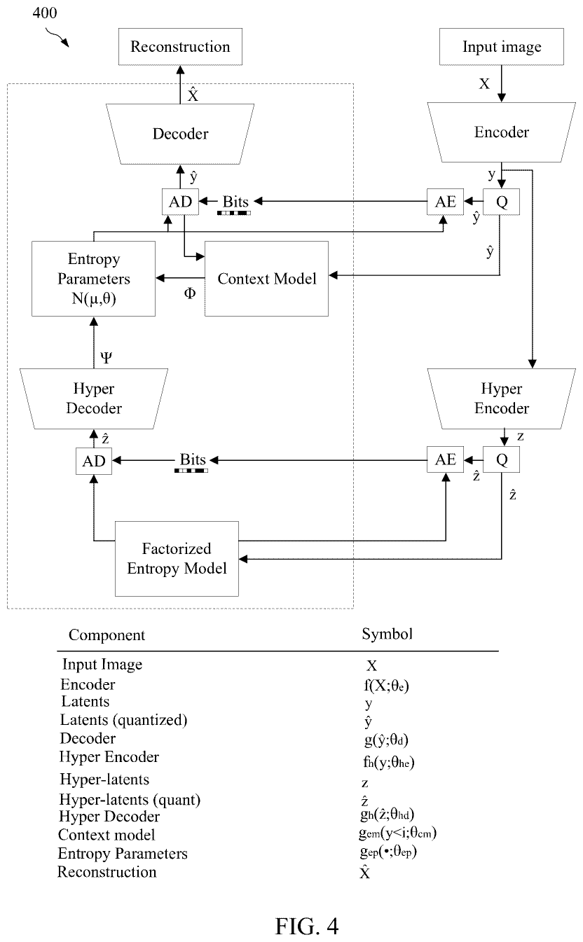

FIG. 4 is a schematic diagram 400 illustrating an example combined model configured to jointly optimize a context model along with a hyperprior and the autoencoder. The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The dashed region corresponds to the components that are executed by the receiver (e.g., a decoder) to recover an image from a compressed bitstream.

An example system utilizes a joint architecture where both a hyper prior model subnetwork (hyper encoder and hyper decoder) and a context model subnetwork are utilized. The hyper prior and the context model are combined to learn a probabilistic model over quantized latents ŷ, which is then used for entropy coding. As depicted in schematic diagram 400, the outputs of the context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

In an example, the latent samples are modeled as gaussian distribution or gaussian mixture models (not limited to). In the example according to the schematic diagram 400, the context model and hyper prior are jointly used to estimate the probability distribution of the latent samples. Since a gaussian distribution can be defined by a mean and a variance (a.k.a., sigma or scale), the joint model is used to estimate the mean and variance (denoted as μ and σ).

### 2.3.5 Gained Variational Autoencoders (G-VAE)

In an example, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c*h*w}, where c, h, w represent the number of channels, the height and width of the latent representation. Each channel of the latent representation is denoted as y₍ᵢ₎∈R^{h*w}, where i=0, 1, . . . , c−1. A pair of gain units include a gain matrix M∈R^{c*n} and an inverse gain matrix, where n is the number of gain vectors. The gain vector can be denoted as mₛ={αₛ₍₀₎, αₛ₍₁₎, . . . , α_{s(c-1)}}, αₛ₍ᵢ₎∈R where s denotes the index of the gain vectors in the gain matrix.

The motivation of gain matrix is similar to the quantization table in JPEG by controlling the quantization loss based on the characteristics of different channels. To apply the gain matrix to the latent representation, each channel is multiplied with the corresponding value in a gain vector.

$${\overline{y}}_{s} = y ⊙ {m}_{s}$$

Where ⊙ is channel-wise multiplication, i.e., y̅ₛ₍ᵢ₎=y₍ᵢ₎×αₛ₍ᵢ₎, and αₛ₍ᵢ₎ is the i-th gain value in the gain vector mₛ. The inverse gain matrix used at the decoder side can be denoted as M′∈R^{c*n}, which consists of n inverse gain vectors, i.e., M′={δₛ₍₀₎, δₛ₍ᵢ₎, . . . , δ_{s(c-1)}}, δₛ₍ᵢ₎∈R. The inverse gain process is expressed as

$${y}_{s}^{′} = \hat{y} ⊙ {m}_{s}^{′}$$

where ŷ is the decoded quantized latent representation and y′ₛ is the inversely gained quantized latent representation, which will be fed into the synthesis network.

To achieve continuous variable rate adjustment, interpolation is used between vectors. Given two pairs of gain vectors

$$\{ {m}_{t} , {m}_{t}^{′} \} and \{ {m}_{r} , {m}_{r}^{′} \} ,$$

the interpolated gain vector can be obtained via the following equations.

$${m}_{ν} = [ {( {m}_{r} )}^{l} \cdot {( {m}_{t} )}^{1 - l} ]$$

$${m}_{ν}^{′} = [ {( {m}_{r}^{′} )}^{l} \cdot {( {m}_{t}^{′} )}^{1 - l} ]$$

where l∈R is an interpolation coefficient, which controls the corresponding bit rate of the generated gain vector pair. Since l is a real number, an arbitrary bit rate between the given two gain vector pairs can be achieved.

### 2.3.6 The Encoding Process Using Joint Auto-Regressive Hyper Prior Model

The design in FIG. 4. corresponds an example combined compression method. In this section and the next, the encoding and decoding processes are described separately.

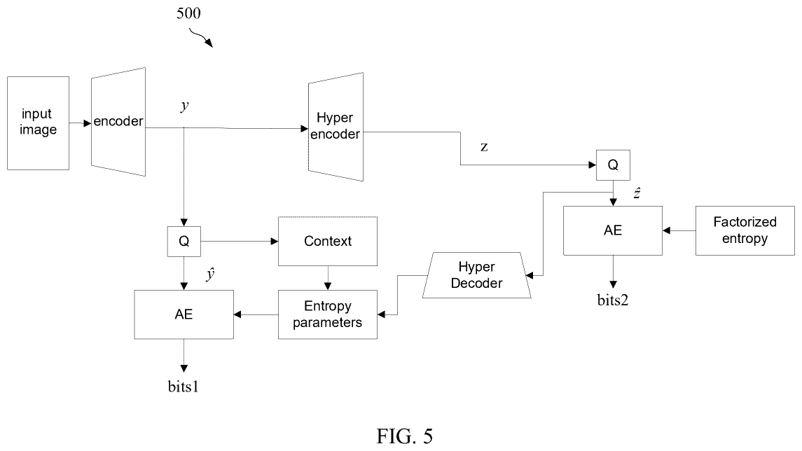

FIG. 5 illustrates an example encoding process 500. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent f. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. The entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent y into bitstream (bits1).

Finally, the first and the second bitstream are transmitted to the decoder as result of the encoding process. It is noted that the other names can be used for the modules described above.

In the above description, all of the elements in FIG. 5 are collectively called an encoder. The analysis transform that converts the input image into latent representation is also called an encoder (or auto-encoder).

### 2.3.7 The Decoding Process Using Joint Auto-Regressive Hyper Prior Model

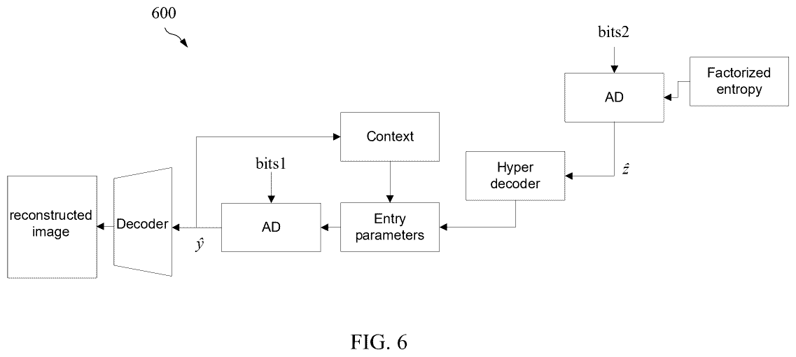

FIG. 6 illustrates an example decoding process 600. FIG. 6 depicts a decoding process separately.

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder.

After the probability distributions (e.g., the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization. Finally, the fully reconstructed quantized latent ŷ is input to the synthesis transform (denoted as decoder in FIG. 6) module to obtain the reconstructed image.

In the above description, the all of the elements in FIG. 6 are collectively called decoder. The synthesis transform that converts the quantized latent into reconstructed image is also called a decoder (or auto-decoder).

### 2.4 Neural Networks for Video Compression

Similar to video coding technologies, neural image compression serves as the foundation of intra compression in neural network-based video compression. Thus, development of neural network-based video compression technology is behind development of neural network-based image compression because neural network-based video compression technology is of greater complexity and hence needs far more effort to solve the corresponding challenges. Compared with image compression, video compression needs efficient methods to remove inter-picture redundancy. Inter-picture prediction is then a major step in these example systems. Motion estimation and compensation is widely adopted in video codecs, but is not generally implemented by trained neural networks.

Neural network-based video compression can be divided into two categories according to the targeted scenarios: random access and the low-latency. In random access case, the system allows decoding to be started from any point of the sequence, typically divides the entire sequence into multiple individual segments, and allows each segment to be decoded independently. In a low-latency case, the system aims to reduce decoding time, and thereby temporally previous frames can be used as reference frames to decode subsequent frames.

### 2.5 Preliminaries

Almost all the natural image and/or video is in digital format. A grayscale digital image can be represented by x∈ [symbol] , where [symbol] is the set of values of a pixel, m is the image height, and n is the image width. For example, [symbol] ={0, 1, 2, . . . ,255} is an example setting, and in this case | [symbol] |=256=2′. Thus, the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] with three separate channels storing Red, Green, and Blue information. Similar to the 8-bit grayscale image, an uncompressed 8-bit RGB image has 24 bpp. Digital images/videos can be represented in different color spaces. The neural network-based video compression schemes are mostly developed in RGB color space while the video codecs typically use a YUV color space to represent the video sequences. In YUV color space, an image is decomposed into three channels, namely luma (Y), blue difference choma (Cb) and red difference chroma (Cr). Y is the luminance component and Cb and Cr are the chroma components. The compression benefit to YUV occur because Cb and Cr are typically down sampled to achieve pre-compression since human vision system is less sensitive to chroma components.

A color video sequence is composed of multiple color images, also called frames, to record scenes at different timestamps. For example, in the RGB color space, a color video can be denoted by X={x₀, x₁, . . . , xₜ, . . . , x_{T-1}} where T is the number of frames in a video sequence and x∈ [symbol] . If m=1080, n=1920, | [symbol] |=2′, and the video has 50 frames-per-second (fps), then the data rate of this uncompressed video is 1920×1080×8×3×50=2,488,320,000 bits-per-second (bps). This results in about 2.32 gigabits per second (Gbps), which uses a lot storage and should be compressed before transmission over the internet.

Usually the lossless methods can achieve a compression ratio of about 1.5 to 3 for natural images, which is clearly below streaming requirements. Therefore, lossy compression is employed to achieve a better compression ratio, but at the cost of incurred distortion. The distortion can be measured by calculating the average squared difference between the original image and the reconstructed image, for example based on MSE. For a grayscale image, MSE can be calculated with the following equation.

$$MSE = \frac{‖ x - \hat{x} {‖}^{2}}{m \times n} \qquad ( 4 )$$

Accordingly, the quality of the reconstructed image compared with the original image can be measured by peak signal-to-noise ratio (PSNR):

$$P S N R = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, the compression ratio given the resulting rate, or vice versa, can be compared. However, to compare different lossy compression methods, the comparison has to take into account both the rate and reconstructed quality. For example, this can be accomplished by calculating the relative rates at several different quality levels and then averaging the rates. The average relative rate is known as Bjontegaard's delta-rate (BD-rate). There are other aspects to evaluate image and/or video coding schemes, including encoding/decoding complexity, scalability, robustness, and so on.

### 2.6 Separate Processing of Luma and Chroma Components of an Image

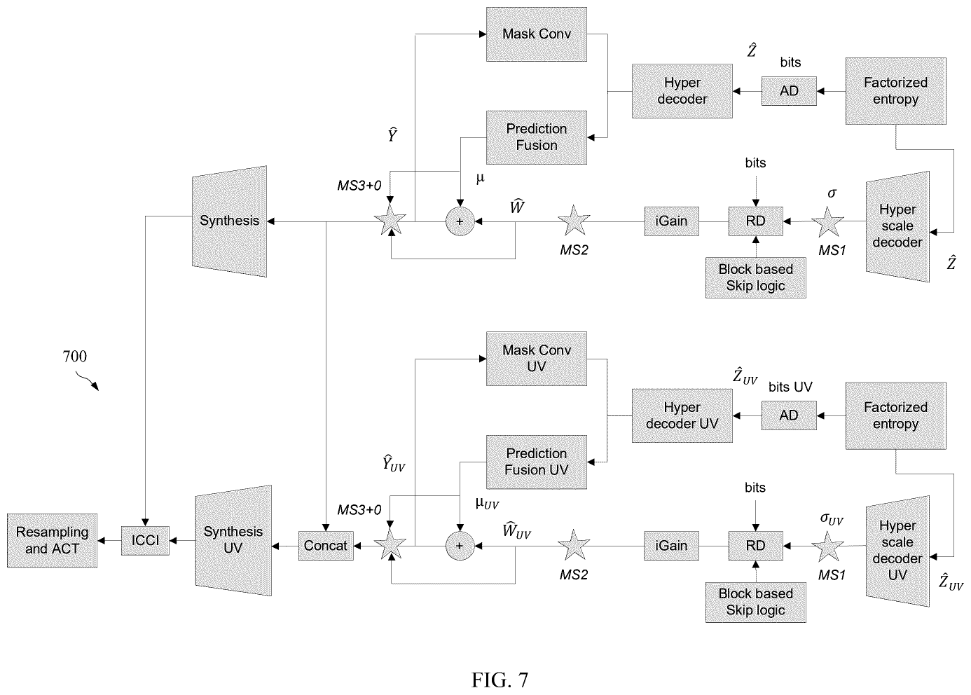

FIG. 7 illustrates an example decoding process 700 according to the present disclosure.

According to one implementation, the luma and chroma components of an image can be decoded using separate subnetworks. In FIG. 7, the luma component of the image is processed by the subnetwoks “Synthesis”, “Prediction fusion”, “Mask Conv”, “Hyper Decoder”, “Hyper scale decoder” etc. Whereas the chroma components are processed by the subnetworks: “Synthesis UV”, “Prediction fusion UV”, “Mask Conv UV”, “Hyper Decoder UV”, “Hyper scale decoder UV” etc.

A benefit of this separate processing is that the computational complexity of the processing of an image is reduced by application of separate processing. Typically, in neural network based image and video decoding, the computational complexity is proportional to the square of the number of feature maps. If the number of total feature maps is equal to 192 for example, computational complexity will be proportional to 192×192. On the other hand if the feature maps are divided into 128 for luma and 64 for chroma (in the case of separate processing), the computational complexity is proportional to 128×128+64×64, which corresponds to a reduction in complexity by 45%. Typically, the separate processing of luma and chroma components of an image does not result in a prohibitive reduction in performance, as the correlation between the luma and chroma components are typically very small.

The processing (Decoding process) in the above figure can be explained below:
1. Firstly, the factorized entropy model is used to decode the quantized latents for luma and chroma, i.e., \hat{z} and \hat{z}ᵤᵥ in FIG. 7.
2. The probability parameters (e.g., variance) generated by the second network are used to generate a quantized residual latent by performing the arithmetic decoding process.
3. The quantized residual latent is inversely gained with the inverse gain unit (iGain) as shown in orange color in FIG. 7. The outputs of the inverse gain units are denoted as ŵ and ŵᵤᵥ for luma and chroma components, respectively.
4. For the luma component, the following steps are performed in a loop until all elements of ŷ are obtained:
   a. A first subnetwork is used to estimate a mean value parameter of a quantized latent (ŷ), using the already obtained samples of ŷ.
   b. The quantized residual latent ŵ and the mean value are used to obtain the next element of ŷ.
5. After all of the samples of ŷ are obtained, a synthesis transform can be applied to obtain the reconstructed image.
6. For chroma component, step 4 and 5 are the same but with a separate set of networks.
7. The decoded luma component is used as additional information to obtain the chroma component. Specifically, the Inter Channel Correlation Information filter sub-network (ICCI) is used for chroma component restoration. The luma is fed into the ICCI sub-network as additional information to assist the chroma component decoding.
8. Adaptive color transform (ACT) is performed after the luma and chroma components are reconstructed.

The module named ICCI is a neural-network based postprocessing module. The examples are not limited to the UCCI subnetwork. Any other neural network based postprocessing module might also be used.

An exemplary implementation of the disclosure is depicted in the FIG. 7 (the decoding process). The framework comprises two branches for luma and chroma components respectively. In each of the branches, the first subnetwork comprises the context, prediction and optionally the hyper decoder modules. The second network comprises the hyper scale decoder module. The quantized hyper latent are \hat{z} and \hat{z}ᵤᵥ, The arithmetic decoding process generates the quantized residual latents, which are further fed into the iGain units to obtain the gained quantized residual latents ŵ and ŵᵤᵥ.

After the residual latent is obtained, a recursive prediction operation is performed to obtain the latent ŷ and ŷᵤᵥ. The following steps describe how to obtain the samples of latent ŷ[:, i,j], and the chroma component is processed in the same way but with different networks.
1. An autoregressive context module is used to generate first input of a prediction module using the samples ŷ[:, m, n] where the (m, n) pair are the indices of the samples of the latent that are already obtained.
2. Optionally the second input of the prediction module is obtained by using a hyper decoder and a quantized hyper latent \hat{z}₁.
3. Using the first input and the second input, the prediction module generates the mean value mean[:, i, j]
4. The mean value mean[:, i,j] and the quantized residual latent ŵ[:, i,j] are added together to obtain the latent ŷ[:, i, j]
5. The steps 1-4 are repeated for the next sample.

Whether to and/or how to apply at least one method disclosed in the disclosure may be signaled from the encoder to the decoder, e.g., in the bitstream.

Whether to and/or how to apply at least one method disclosed in the disclosure may be determined by the decoder based on coding information, such as dimensions, color format, etc.

Further, the modules named MS1, MS2 or MS3+O (in FIG. 7), might be included in the processing flow. The said modules might perform an operation to their input by multiplying the input with a scalar or adding an adding an additive component to the input to obtain the output. The scalar or the additive component that are used by the said modules might be indicated in a bitstream.

The module named RD or the module named AD in the FIG. 7 might be an entropy decoding module. It might be a range decoder or an arithmetic decoder or the like.

The examples described herein is not limited to the specific combination of the units exemplified in FIG. 7. Some of the modules might be missing and some of the modules might be displaced in processing order. Also, additional modules might be included. For example:
1. The ICCI module might be removed. In that case the output of the Synthesis module and the Synthesis UV module might be combined by means of another module, that might be based on neural networks.
2. One or more of the modules named MS1, MS2 or MS3+O might be removed. The core of the disclosure is not affected by the removing of one or more of the said scaling and adding modules.

In FIG. 7, other operations that are performed during the processing of the luma and chroma components are also indicated using the star symbol. These processes are denoted as MS1, MS2, MS3+O. These processing might be, but not limited to, adaptive quantization, latent sample scaling, and latent sample offsetting operations. For example, in an adaptive quantization process might correspond to scaling of a sample with multiplier before the prediction process, wherein the multiplier is predefined or whose value is indicated in the bitstream. The latent scaling process might correspond to the process where a sample is scaled with a multiplier after the prediction process, wherein the value of the multiplier is either predefined or indicated in the bitstream. The offsetting operation might correspond to adding an additive element to the sample, again wherein the value of the additive element might be indicated in the bitstream or inferred or predetermined.

Another operation might be tiling operation, wherein samples are first iled (grouped) into overlapping or non-overlapping regions, wherein each region is processed independently. For example the samples corresponding to the luma component might be divided into tiles with a file height of 20 samples, whereas the chroma components might be divided into tiles with a file height of 10 samples for processing.

Another operation might be application of wavefront parallel processing. In wavefront parallel processing, a number of samples might be processed in parallel, and the amount of samples that can be processed in parallel might be indicated by a control parameter. The said control parameter might be indicated in the bitstream, be inferred, or can be predetermined. In the case of separate luma and chroma processing, the number of samples that can be processed in parallel might be different, hence different indicators can be signalled in the bitstream to control the operation of luma and chrome processing separately.

### 2.7 Colors Separation and Conditional Coding

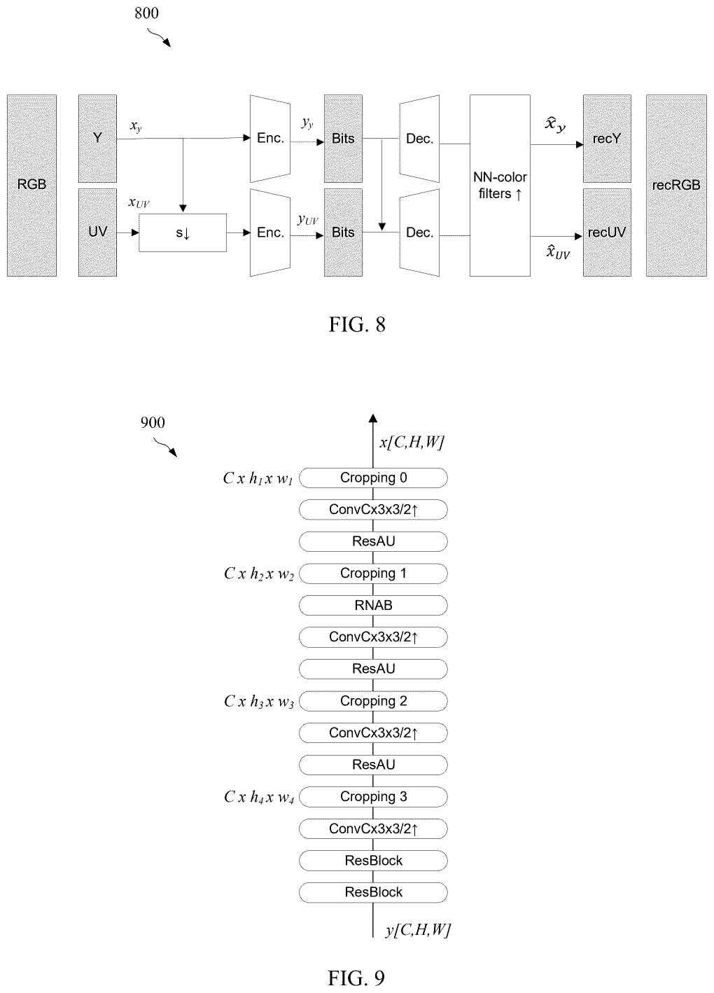

FIG. 8 illustrates an example learning-based image codec architecture 800.

In one example the primary and secondary color components of an image are coded separately, using networks with similar architecture, but different number of channels as shown in FIG. 8. All boxes with same names are sub-networks with the similar architecture, only input-output tensor size and number of channels are different. Number of channels for primary component is C_{ρ}=128, for secondary components is Cₛ=64. The vertical arrows (with arrowhead pointing downwards) indicate data flow related to secondary color components coding. Vertical arrows show data exchange between primary and secondary components pipelines.

The input signal to be encoded is notated as x, latent space tensor in bottleneck of variational auto-encoder is y. Subscript “Y” indicates primary component, subscript “UV” is used for concatenated secondary components, there are chroma components.

First the input image that has RGB color format is converted to primary (Y) and secondary components(UV). The primary component x_{γ} is coded independently from secondary components xᵤᵥ and the coded picture size is equal to input/decoded picture size. The secondary components are coded conditionally, using x_{γ} as auxiliary information from primary component for encoding xᵤᵥ and using ŷ_{γ} as a latent tensor with auxiliary information from primary component for decoding ŷᵤᵥ reconstruction. The codec structure for primary component and secondary components are almost identical except the number of channels, size of the channels and the several entropy models for transforming latent tensor to bitstream, therefore primary and secondary latent tensor will generate two different bitstream based on two different entropy models. Prior to the encoding x_{γ}, xᵤᵥ goes through a module which adjusts the sample location by down-sampling (marked as “s⬇” on FIG. 8), this essentially means that coded picture size for secondary component is different from the coded picture size for primary component. The scaling factor s is variable, but the default scaling factor is s=2. The size of auxiliary input tensor in conditional coding is adjusted in order the encoder receives primary and secondary components tensor with the same picture size. After reconstruction, the secondary component is rescaled to the original picture size with a neural-network based upsampling filter module (“NN-color filter s⬆” on FIG. 8), which outputs secondary components up-sampled with factor s.

The example in FIG. 8 exemplifies an image coding system, where the input image is first transformed into primary (Y) and secondary components (UV). The outputs \hat{x}_{γ}, \hat{x}ᵤᵥ are the reconstructed outputs corresponding to the primary and secondary components. At the and of the processing, \hat{x}_{γ}, \hat{x}ᵤᵥ are converted back to RGB color format. Typically the xᵤᵥ is downsampled (resized) before processing with the encoding and decoding modules (neural networks). For example the size of the xᵤᵥ might be reduced by a factor of 50% in each of the vertical and horizontal dimensions. Therefore the processing of the secondary component includes approximately 50%×50%=25% less samples, therefore it is computationally less complex.

### 2.8 Cropping Operation in Neural Network Based Coding

FIG. 9 illustrates an example synthesis transform for learning based image coding 900.

The example synthesis transform above includes a sequence of 4 convolutions with up-sampling with stride of 2. The synthesis transform sub-Net is depicted on FIG. 9. The size of the tensor in different parts of synthesis transform before cropping layer is the diagram on FIG. 9.

The cropping layer changes tensor size h_{d}×w_{d} to h_{d-1}×w_{d-1}, where h_{d}=2·ceil(H/2^{d}); w_{d}=2·ceil(W/2^{d}); here d is the depth of proceeding convolution in the codec architecture. For primary component Synthesis Transform receives input tensor with size h×w; h=ceil(H/16); w=ceil(W/16). The output of Synthesis Transform for primary component is 1×h₀×w₀, where h₀=H; h₀=W.

For secondary component Synthesis Transform receives input tensor with size hᵤᵥ×wᵤᵥ; hᵤᵥ=ceil(ceil(H/s)/16); wᵤᵥ=ceil(ceil(W/s)/16). The output of the Synthesis Transform for primary component is 2×h₀×wᵤᵥ₀, where h_{UV0}=ceil(H/s); h₀=ceil(W/s). For secondary components input sizes are h₀=ceil(H/s); w₀=ceil(W/s), where s is the scale factor. The scale factor might be 2 for example, wherein the secondary component is downsampled by a factor of 2.

Based on the above explanation, the operation of the cropping layers depend on the output size H,W and the depth of the cropping layer. The depth of the left-most cropping layer in FIG. 9 is equal to 0. The output of this cropping layer must be equal to H, W (the output size), if the size of the input of this cropping layer is greater than H or W in horizontal or vertical dimension respectively, cropping needs to be performed in that dimension. The second cropping layer counting from left to right has a depth of 1. The output of the second cropping layer must be equal to h₁=2·ceil(H/2¹); w₁=2·ceil(W/2¹), which means if the input of this second cropping layer is greater than h1, w1 in any dimension, than cropping is applied in that dimension. In summary, the operation of cropping layers are controlled by the output size H,W. In one example if H and W are both equal to 16, then the cropping layers do not perform any cropping. On the other hand if H and W are both equal to 17, then all 4 cropping layers are going to perform cropping.

### 2.9 Bitwise Shifting

The bitwise shift operator can be represented using the function bitshift(x,n), where n is an integer number. If n is greater than 0, it corresponds to right-shift operator (>>), which moves the bits of of the input to the right, and the left-shift operator (<<), which moves the bits to the left. In another words the bitshift(x, n) operation corresponds to:

$$bitshift ( x , n ) = x * {2}^{n}$$

$$bitshift ( x , n ) = floor ( x * {2}^{n} )$$

$$bitshift ( x , n ) = x // {2}^{n}$$

The output of the bit shift operation is an integer value. In some implementations, the floor( ) function might be added to the definition.

Floor(x) is equal to the largest integer less than or equal to x.

The “//” operator or the integer division operator: It is an operation that comprises division and truncation of the result toward zero. For example, 7/4 and −7/−4 are truncated to 1 and −7/4 and 7/−4 are truncated to −1.

$$rightshift ( x , n ) = x >> n or$$

$$leftshift ( x , n ) = x << n$$

Equation 3: alternative implementation of the bit shift operator as rightshift or leftshift.
x>>y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.
x<<y Arithmetic left shift of a two's complement integer representation of x by y binary digits. This function is defined only for non-negative integer values of y. Bits shifted into the least significant bits (LSBs) as a result of the left shift have a value equal to 0.

### 2.10 Convolution Operation

The convolution operation starts with a kernel, which is a small matrix of weights. This kernel “slides” over the input data, performing an elementwise multiplication with the part of the input it is currently on, and then summing up the results into a single output pixel. In some cases, the convolution operation might comprise a “bias”, which is added to the output of the elementwise multiplication operation.

### 2.11 Leaky_Relu Activation Function

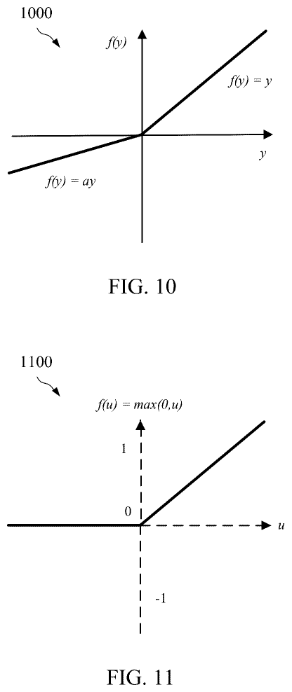

FIG. 10 illustrates an example leaky ReLU activation function 1000. The leaky_ReLU activation function is depicted in FIG. 10. According to the function, if the input is a positive value, the output is equal to the input. If the input (y) is a negative value, the output is equal to a*y. The a is typically (not limited to) a value that is smaller than 1 and greater than 0. Since the multiplier a is smaller than 1, it can be implemented either as a multiplication with a non-integer number, or with a division operation. The multiplier a might be called the negative slope of the leaky ReLU function.

### 2.12 Relu Activation Function

FIG. 11 illustrates an example ReLU activation function 1100. The ReLU activation function is depicted in FIG. 11. According to the function, if the input is a positive value, the output is equal to the input. If the input (y) is a negative value, the output is equal to 0.

### 3. Technical Problems Solved by Disclosed Technical Solutions

In an image or video compression system, typically an arithmetic coding or other forms of entropy coding methods are employed to convert symbols to string of bits. The process of converting the symbols into bits is a sequential process, which means a small error (e.g., a single bit interpreted as “0” instead of “1”) could cause the whole bitstream to be corrupted, rendering the decoding of the image impossible.

The layers that are used in example neural network implementations comprise operations that include:
Multiplication with floating point number,
Division operation,
Addition with a floating point number,
Rounding operation.
. . .

Such operations are not well defined, and hence the output value might be different from device to device. This small difference might be negligible for most of the applications, however in the case of image and video compression, the small difference can cause a bitstream to be undecodable. The reason is, a single error in decoding of a single bit will impact the interpretation of all of the following bits, corrupting the whole bitstream.

As a result a neural network based image or video coding system is susceptible to decoding errors. A bitstream encoded in one device might not be decodable in another device.

### 4. a Listing of Solutions and Embodiments

According to the disclosure abasic unit comprising a convolution layer and an activation layer is provided. The said basic unit is designed in such a way that all of the operations performed by the basic unit can be performed using integer numbers. Furthermore, any function whose result might depend on the device is not used (e.g., rounding operation or division operation). Instead rounding or division operations are replaced by bitwise shifting.

### 4.1 Central Examples

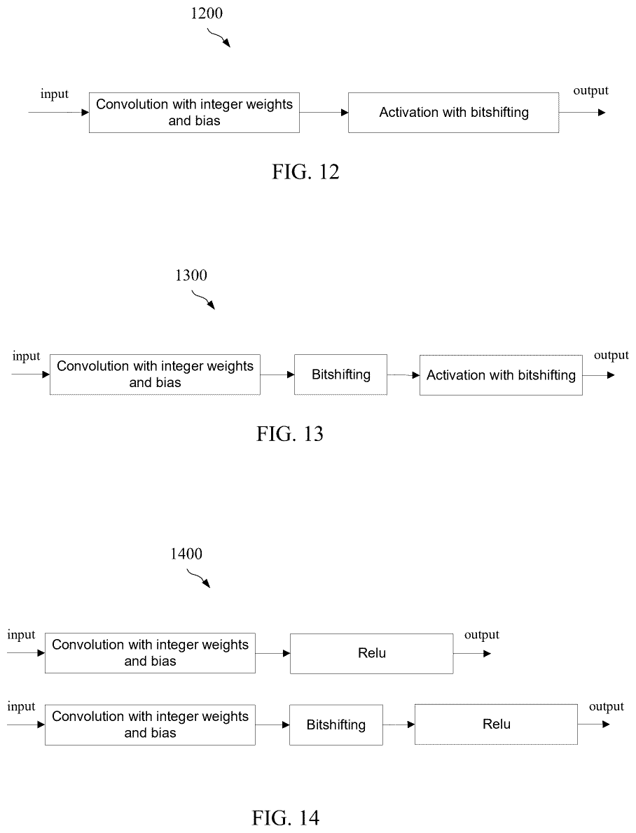

FIG. 12 illustrates an example basic unit 1200 according to disclosure. FIG. 13 illustrates another example basic unit 1300 according to disclosure.

In image and video coding using neural networks, convolution layer is employed very frequently. The disclosed examples are depicted in FIGS. 12 and 13. According to the examples a basic convolution and activation layer is presented. If the input of the said unit is integer, then the basic unit guarantees that all of the operations that are performed to obtain the output can be done using integer numbers.

The basic unit (basic convolution and activation unit) is depicted in FIGS. 12 and 13.

According to the examples, firstly all of the parameters of the convolution layer (the first function operating on the input) are integer numbers. A convolution operation parameters might comprise a kernel (which are the numbers multiplied with the input) and a bias (the numbers that are added to the output of the multiplication). If the size of the kernel is 3×3 for example, a two dimensional (2D) convolution operation might be expressed using the equation below:

$$result [ i , j ] = {\sum }_{m = - 1 , n = - 1}^{1 , 1} in [ i + m , j + n ] * kernel [ m , n ] + bias$$

The above mathematical formula describes a 2D convolution operation, with a kernel size of 3×3. The disclosure is applicable to any convolution operation, regardless of the dimension, size of the kernel, bias (can be a vector or a scalar or a matrix).

According to the examples, firstly the weights of the kernel (which are used to elementwise multiply with the input) and the values of the bias are all integer. Any non-integer value is disallowed. Therefore since the convolution operation is composed of multiplications and additions, if the input of the convolution operation is integer, the output of the convolution operation is guaranteed to be integer. Secondly a novel activation layer is employed (“Quantized leaky ReLU”) which does not require any division operation, any rounding operation and any multiplication with a non-integer. The “Quantized leaky ReLU” layer, which corresponds to the activation function of the basic unit which may be described with equations with integer operations only, such as the following equations:

$$f ( x , n , A , B , C ) = \{ \begin{matrix}bitshift ( x , n ) & if x \geq 0 \\ bitshift ( ( - x ) * A + B , n + C ) & if x < 0\end{matrix}$$

$$or$$

$$f ( x , n , A , B , C ) = \{ \begin{matrix}floor ( \frac{1}{{2}^{n}} ) & if x \geq 0 \\ - floor ( \frac{( - x ) * A + B}{{2}^{n + C}} ) & if x < 0\end{matrix}$$

$$or$$

$$f ( x , n , A , B , C ) = \{ \begin{matrix}floor ( bitshift ( x , n ) ) & if x \geq 0 \\ - floor ( bitshift ( ( - x ) * A + B , n + C ) & if x < 0\end{matrix}$$

$$or$$

$$f ( x , n , A , B , C ) = \{ \begin{matrix}bitshift ( x + {2}^{n - 1} , n ) & if x \geq 0 \\ - bitshift ( ( - x ) * A + B , n + C ) & if x < 0\end{matrix}$$

$$O r$$

$$f ( x , n , A , B , C ) = \{ \begin{matrix}bitshift ( x , n ) & if x \geq 0 \\ - bitshift ( ( - x ) * A + B , n + C ) & if x < 0\end{matrix}$$

wherein the bitshift(x, n) operation corresponds to bitwise shift operator.

It is noted that division operation followed by floor( ) operation is just a different representation of the bit shifting operation. In other words it can be implemented using bit shift( ) operator.

In another implementation, a division operation may be replaced by a series of operations, depending on at least one lookup table.

### 4.2 Details of the Examples

The “Quantized leaky ReLU” layer is an activation layer, wherein all processes are performed using integer numbers. The general form of the quantized leaky ReLU function might be exemplified in by equations in section 4.1.

In one example the n is equal to zero. In this case the “Quantized leaky ReLU” function might be described as:

$$f ( x , A , B , C ) = \{ \begin{matrix}x & if x \geq 0 \\ - floor * ( \frac{( - x ) * A + B )}{{2}^{C}} ) & if x < 0\end{matrix}$$

$$or$$

$$f ( x , A , B , C ) = \{ \begin{matrix}x & if x \geq 0 \\ - bitshift ( ( - x ) * A + B , C ) & if x < 0\end{matrix}$$

$$…$$

In the above, the constants A, B and C are integer numbers and can be determined in such a way to approximate a regular leaky_ReLU function. For example if the negative slope of the leaky ReLU is 0.01, the A, B and C can be set as: round(2^{m}*0.01), 0 and m respectively. For example m might be 13. In this case A is equal to 82 and C is equal to 13. In this case the A/2c is equal to 82/8192 which is a number which is close to 0.01. In other words by setting the A, B and C, it is possible to approximate the negative slope of a leaky ReLU function only using integer numbers and bit shift operation.
In another example the A, B and C can be set as round(2^{m}*0.01), 2^{m-1} and m. Compared to the previous example (where B is equal to 0), the B is set to be equal to 2^{m-1}. As a result the output of the quantized leaky ReLU function becomes more precise, since the floor operation becomes more precise. If B is set equal to 2^{m-1} and added to the nominator before the floor operation, the output of the floor( ) operation becomes the nearest integer value. It is noted that in this example and in the above example, the round( ) operation is used only once during the determination of the number A. in other words the round operation does not need to be performed by a computing device every time, once the value of A is computed, this pre-computed value can be used by the computing device.
In other words the A,B and C might be selected in such a way to approximate an arbitrary negative slope of a leaky ReLU function, which is typically a floating point number between 0 and 1 or 0 and −1. A, B and C might be selected in such a way that the negative slope can be approximated arbitrarily closely.

An alternative implementation of the disclosure can be described as:

$$f ( x , A , B , C ) = \{ \begin{matrix}x & if x \geq 0 \\ - bitshift ( ( - x ) * A + B , C ) & if x < 0\end{matrix}$$

In the example above, the floor( ) operation and the division operation (by 2^{c}) is replaced with bit shift operation. This is just an alternative representation of the same mathematical formula. In computer science, the bit shift operation can be represented by a division operation (or a multiplication operation) followed by a floor function.

In another example A, B and C might be set in such a way to approximate another value of a slope of a leaky ReLU function. Since A, B and C are all integers valued numbers, and since bit shift operation used, the approximation is very friendly for implementation in a computation device.

In the examples, the B is typically equal to zero if the bit shifting is a left shift operation (e.g., the bit shifting operation is equivalent to multiplication with a number greater than 1). If the bit shifting is a right shift operation, then B might be greater than 0, in order to improve the precision of the right shift operation.

Multiplication and addition operations with integer numbers and bit shifting operation are well defined operations in computer hardware. On the other hard operations with floating points and division operations are not well defined, and hence the output value might be different from device to device. This small difference might be negligible for most of the applications, however in the case of image and video compression, the small difference can cause a bitstream to be undecodable. The reason is, a single error in decoding of a single bit will impact the interpretation of all of the following bits, corrupting the whole bitstream.

The implementation of the negative slope of a leaky ReLU function using integer numbers A, B and C and bit shifting operation ensures that the result of the quantized leaky ReLU function is identical in any computing device. Therefore a bitstream that is encoded with one device (e.g., a computer) is decodable by another device (e.g., a mobile computing device).

Another implementation of the disclosure is:

$$f ( x , n , A , B , C ) = \{ \begin{matrix}bitshift ( x + D , n ) & if x \geq 0 \\ - bitshift ( ( - x ) * A + B , n + C ) & if x < 0\end{matrix}$$

In this implementation the input is bit shifted by n bits, both in the positive and in the negative branch. In this case D might be equal to zero. Or it might be an integer value greater than zero, e.g., it might be equal to 2ⁿ⁻¹.

In another example the basic convolution and activation layer is presented which comprise a convolution layer with integer weights and bias values and a ReLU function. The 2 alternative implementations of the basic convolution and activation layer might be depicted in the figure below:

FIG. 14 illustrates another example basic unit 1400 according to disclosure.
The above examples are special version of the disclosure, wherein the quantized leaky ReLU function is replaced with ReLU function. The reason is, since the negative slope of the ReLU function is equal to zero, if its input it an integer value, its output is also an integer value. Moreover the ReLU function does not include any multiplication with floating point number or division, therefore it is a function that is suitable for implementation in computing hardware.

According to the disclosure, if the input of the basic unit (basic convolution and activation layer) is integer valued, then the output is guaranteed to be integer valued. Moreover, the operations that may be performed by the unit comprise:
Multiplication with integer,
Bit shifting operation,
Addition with an integer.
Clipping
Rounding

Therefore, no division, multiplication/addition with a non-integer value or rounding operation is necessary, which are operations that are device dependent (whose output might change when performed on different devices).

According to the disclosure additional layers might be included between the convolution layer and the activation layer. A possible layer that might be included between the convolution layer and activation layer might be a cropping layer as exemplified in section 2.8. In general any layer that does not include any device dependent operation (such as operations with floating point or division or rounding etc.) might be included between the convolution and the activation layer.

According to the disclosure a subnetwork might be designed using the invented basic unit (the basic convolution and activation unit). One or multiple basic units might be used to construct a neural subnetwork.

Alternatively or in addition, a quantization operation might be performed on the output of the basic unit. For example, a table which comprise only integer values might be used for quantization of the output of the basic unit.

An example table might be as follows:

| Quantization levels | Quantized output value |
|---|---|
| 0 | 0 |
| 110 | 1 |
| 228 | 2 |
| 448 | 3 |
| 986 | 4 |
| . . . | . . . |

According to the example table above, if an input value is between 0 and 110, it is quantized to assume the output value 0. If the input value of the quantization is between 228 and 448, the output value is equal to 2.

Since the output of the basic unit is an integer value, the quantization table such as above can be used (that comprise only integer quantization values) to quantize the output of the basic unit. The quantization operation is basically a mapping function between an integer input and an integer output. As a result the implementation of such a quantizer is also device independent.

According to one example, a neural network based hyper scale decoder module is constructed using the basic units. The output of the hyper scale decoder is the probability parameters, e.g., gaussian variance parameters.

### 4.3 Benefits of the Examples

According to the disclosure, if the input of the basic unit (basic convolution and activation layer) is integer valued, then the output is guaranteed to be integer valued. Moreover, the operations that are performed by the unit are:
Multiplication with integer,
Bit shifting operation,
Addition with an integer.

Therefore, no division, multiplication/addition with a non-integer value or rounding operation is necessary, which are operations that are device dependent (whose output might change when performed on different devices).

The basic unit (basic convolution and activation layer) that is presented in the disclosure ensures that a neural subnetwork implemented with such basic unit device independent. In other words, output of a subnetwork that is implemented using such basic unit is guaranteed to provide identical output in any computing device. Therefore, a bitstream that is encoded with one device (e.g., a computer) is decodable by another device (e.g., a mobile computing device), which is a fundamental requirement for image encoding/decoding.

### 5. Embodiments

### 1. Decoder Claim:

An image or video decoding method, comprising a neural subnetwork, that comprise the steps of:
Performing a convolution operation,
Performing an activation function on the output of the convolution operation,
Obtaining a reconstructed image according to the output of the said neural subnetwork wherein the said convolution and activation functions are performed only using integer values.

### 6. References

[1] Z. Cheng, H. Sun, M. Takeuchi and J. Katto, “Learned image compression with discretized gaussian mixture likelihoods and attention modules,” in Proceedings of the IEEE/CVF Conference on Computer Vision and Pattern Recognition, pp. 7939-7948, 2020.
[2] B. Bross, J. Chen, S. Liu and Y.-K. Wang, “Versatile Video Draft (Draft 10),” JVET-S2001, Jul. 2020.
[3] R. D. Dony and S. Haykin, “Neural network approaches to image compression,” Proceedings of the IEEE, vol. 83, no. 2, pp. 288-303, 1995.
[4] Z. Wang, A. C. Bovik, H. R. Sheikh, and E. P. Simoncelli, “Image quality assessment: From error visibility to structural similarity,” IEEE Transactions on Image Processing, vol. 13, no. 4, pp. 600-612, 2004.
[5] G. Bjontegaard, “Calculation of average PSNR differences between RD-curves,” VCEG, Tech. Rep. VCEG-M33, 2001.
[6] C. E. Shannon, “A mathematical theory of communication,” Bell System Technical Journal, vol. 27, no. 3, pp. 379-423, 1948.
[7] G. E. Hinton and R. R. Salakhutdinov, “Reducing the dimensionality of data with neural networks,” Science, vol. 313, no. 5786, pp. 504-507, 2006.
[8] J. Ballé, D. Minnen, S. Singh, S. Hwang and N. Johnston, “Variational image compression with a scale hyperprior,” in International Conference on Learning Representations, 2018.
[9] D. Minnen, J. Ballé, G. Toderici, “Joint Autoregressive and Hierarchical Priors for Learned Image Compression”, arXiv.1809.02736. 1, 2, 3, 4, 7.

FIG. 15 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as wireless fidelity (Wi-Fi) or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present disclosure may be embodied in various electronic devices such as mobile phones, laptops, smartphones or other devices that are capable of performing digital data processing and/or video display.

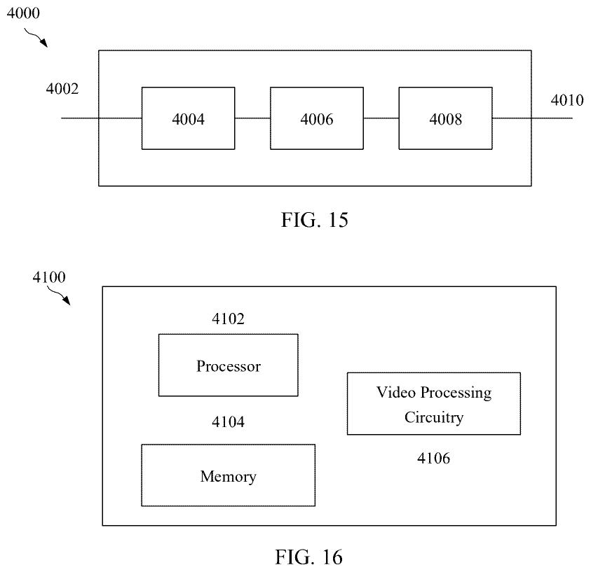

FIG. 16 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and techniques described herein. The video processing circuitry 4106 may be used to implement, in hardware circuitry, some techniques described in the present disclosure. In some embodiments, the video processing circuitry 4106 may be at least partly included in the processor 4102, e.g., a graphics co-processor.

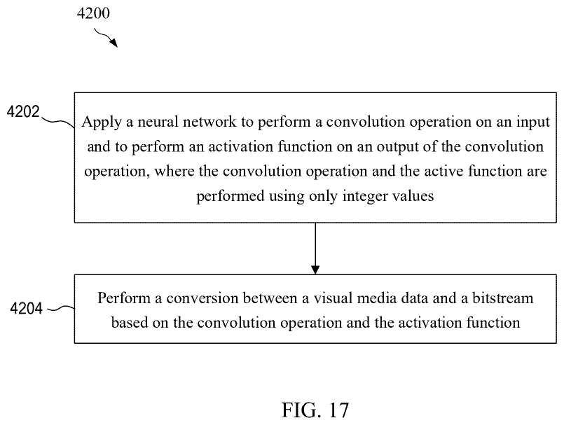

FIG. 17 is a flowchart for an example method 4200 of video processing. At step 402, a determination is made to apply a neural subnetwork to perform a convolution operation using only integer values and perform an activation function on the output of the convolution operation using only integer values. At step 4204, a conversion is performed between a visual media data and a bitstream based on the convolution operation and the activation function. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200. Further, a non-transitory computer-readable recording medium may store a bitstream of a video which is generated by the method 4200 as performed by a video processing apparatus. In addition, the method 4200 can be performed by an apparatus for processing video data comprising a processor and a non-transitory memory with instructions thereon. The instructions, upon execution by the processor, cause the processor to perform method 4200.

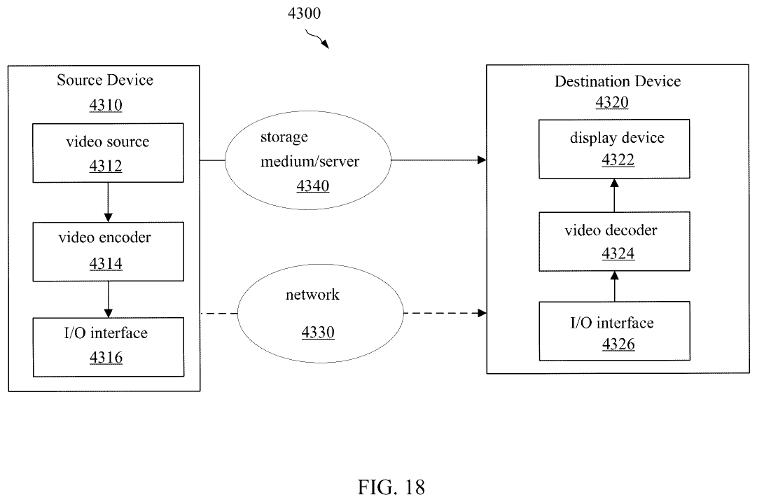

FIG. 18 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of apicture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

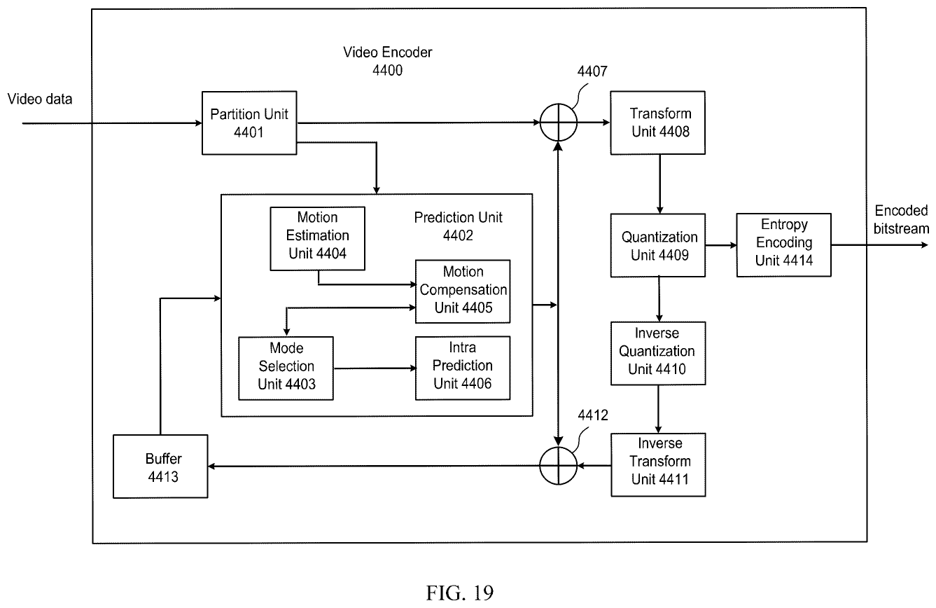

FIG. 19 is a block diagram illustrating an example of video encoder 4400, which may be video encoder 4314 in the system 4300 illustrated in FIG. 18. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

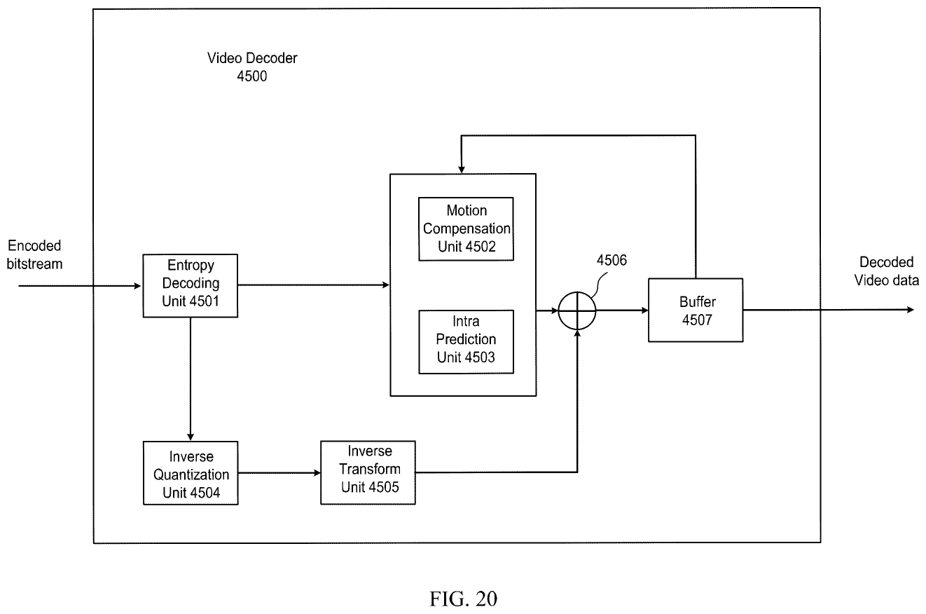

FIG. 20 is a block diagram illustrating an example of video decoder 4500 which may be video decoder 4324 in the system 4300 illustrated in FIG. 18. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intraprediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

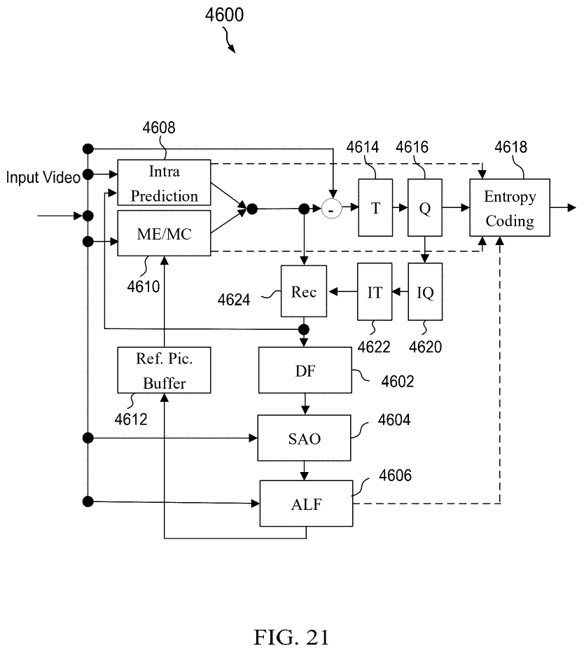

FIG. 21 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of techniques discussed herein.
1. A method for processing video data comprising: determining to apply a neural subnetwork to perform a convolution operation using only integer values and perform an activation function on the output of the convolution operation using only integer values; and performing a conversion between visual media data and a bitstream based on the convolution operation and the activation function.
2. The method of solution 1, wherein the convolution operation employs a kernel of integer weights and an integer bias.
3. The method of any of solutions 1-2, wherein the activation function employs bit-shifting.
4. The method of any of solutions 1-3, wherein the convolution operation is performed according to:

$$result [ i , j ] = {\sum }_{m = - 1 , n = - 1}^{1 , 1} in [ i + m , j + n ] * kernel [ m , n ] + bias .$$

5. The method of any of solutions 1-4, wherein the convolution operation disallows non-integer values by employing only multiplications and additions onto integer inputs.
6. The method of any of solutions 1-5, wherein the activation function includes a quantized leaky ReLU function or a ReLU function that does not include division and does not include non-integer multiplication.
7. The method of any of solutions 1-6, wherein the activation function is performed according to:

$$f ( x , n , A , B , C ) = \{ \begin{matrix}bitshift ( x , n ) & if x \geq 0 \\ - bitshift ( ( - x ) * A + B , n + C ) & if x < 0\end{matrix} ;$$

$$f ( x , n , A , B , C ) = \{ \begin{matrix}floor ( \frac{x}{{2}^{n}} ) & if x \geq 0 \\ - floor ( \frac{( x ) * A + B}{{2}^{n + C}} ) & if x < 0\end{matrix} ;$$

$$f ( x , n , A , B , C ) = \{ \begin{matrix}floor ( bitshift ( x , n ) ) & if x \geq 0 \\ - floor ( bitshift ( ( - x ) * A + B , n + C ) ) & if x < 0\end{matrix} ;$$

$$f ( x , n , A , B , C ) = \{ \begin{matrix}bitshift ( x + {2}^{n - 1} , n ) & if x \geq 0 \\ - bitshift ( ( - x ) * A + B , n + C ) & if x < 0\end{matrix} ; or$$

$$f ( x , n , A , B , C ) = \{ \begin{matrix}bitshift ( x , n ) & if x \geq 0 \\ - bitshift ( ( - x ) * A + B , n + C ) & if x < 0\end{matrix} .$$

8. The method of any of solutions 1-7, wherein the activation function is performed according to:

$$f ( x , A , B , C ) = \{ \begin{matrix}x & if x \geq 0 \\ - floor ( \frac{( - x ) * A + B}{{2}^{C}} ) & if x < 0\end{matrix} ; or$$

$$f ( x , A , B , C ) = \{ \begin{matrix}x & if x \geq 0 \\ - bitshift ( ( - x ) * A + B , C ) & if x < 0\end{matrix} .$$

9. The method of any of solutions 1-8, wherein the activation function is performed according to:

$$f ( x , n , A , B , C ) = \{ \begin{matrix}bitshift ( x + D , n ) & if x \geq 0 \\ - bitshift ( ( - x ) * A + B , n + C ) & if x < 0\end{matrix} .$$

10. The method of any of solutions 1-9, wherein the convolution operation and the activation function consist essentially of multiplication with integer values, bit-shifting operations, addition with integer values, clipping, rounding, and combinations thereof.
11. The method of any of solutions 1-10, wherein the neural subnetwork further comprises a cropping layer.
12. The method of any of solutions 1-11, wherein the neural subnetwork further comprises a quantization operation.
13. The method of any of solutions 1-12, wherein the neural subnetwork is included in a hyper scale decoder that outputs probability parameters.
14. An apparatus for processing video data comprising: a processor; and a non-transitory memory with instructions thereon, wherein the instructions upon execution by the processor, cause the processor to perform the method of any of solutions 1-13.
15. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-13.
16. A non-transitory computer-readable recording medium storing a bitstream of a video which is generated by a method performed by a video processing apparatus, wherein the method comprises: determining to apply a neural subnetwork to perform a convolution operation using only integer values and perform an activation function on the output of the convolution operation using only integer values; and generating a bitstream based on the determining.
17. A method for storing bitstream of a video comprising: determining to apply a neural subnetwork to perform a convolution operation using only integer values and perform an activation function on the output of the convolution operation using only integer values; generating a bitstream based on the determining; and storing the bitstream in a non-transitory computer-readable recording medium.
18. A method, apparatus or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field programmable gate array (FPGA) or an application specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of particular techniques. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing video or image data, comprising:
applying a basic unit to perform a convolution operation on an input and to perform an activation function on an output of the convolution operation, wherein the convolution operation is performed using only integer values; and
performing a conversion between visual media data and a bitstream based on the convolution operation and the activation function.

2. The method of claim 1, wherein the input comprises only integer values, and wherein the output of the convolution operation comprises only integer values.

3. The method of claim 1, wherein the convolution operation employs a kernel of integer weights and an integer bias, wherein the integer weights are elementwise multiplied with the input, and wherein the integer bias is added to a result of elementwise multiplying the integer weights with the input.

4. The method of claim 3, wherein a size of the kernel is 3×3,
wherein the convolution operation is a two-dimensional convolution operation and performed according to:
$$result [ i , j ] = {\sum }_{m = - 1 , n = - 1}^{1 , 1} in [ i + m , j + n ] * kernel [ m , n ] + bias ,$$
where kernel[m, n] indicates the kernel, bias indicates the integer bias, in[i+m, j+n] indicates the input, result[i, j] indicates the output of the convolution operation, m, n, i, and j are all integer values, i is greater than or equal to 0 and less than or equal to (W−1), j is greater than or equal to 0 and less than or equal to (H−1), W is a width of the output of the convolution operation, H is a height of the output of the convolution operation.

5. The method of claim 3, wherein the method is applicable to any convolution operation, regardless of dimension, a size of the kernel, and the integer bias, and
wherein the method is performed without any device dependent operation, wherein the device dependent operation comprises at least one of: a division operation with a non-integer value, a multiplication operation with a non-integer value, an addition operation with a non-integer value, or a rounding operation.

6. The method of claim 1, wherein the activation function is performed using only integer values, wherein the activation function employs a bit shifting operation,
wherein non-integer values are disallowed for the convolution operation and for the activation function,
wherein the convolution operation disallows non-integer values by employing only multiplications and additions using integer values,
wherein the convolution operation is performed using only multiplication with integer values and addition with integer values.

7. The method of claim 1, wherein the convolution operation is implemented by a convolution layer with integer weights and integer bias, and the activation function comprises a rectified linear unit (ReLU) function or a quantized leaky ReLU function, and
wherein any division operation with a non-integer value, any rounding operation, or any multiplication operation with a non-integer value is disallowed to be used in the activation function.

8. The method of claim 1, wherein the activation function is performed according to one or combination of:
$$f ( x , n , A , B , C ) = \{ \begin{matrix}bitshift ( x , n ) & if x \geq 0 \\ - bitshift ( ( - x ) * A + B , n + C ) & if x < 0\end{matrix} ; or$$
$$f ( x , n , A , B , C ) = \{ \begin{matrix}floor ( \frac{2}{{2}^{n}} ) & if x \geq 0 \\ - floor ( \frac{( x ) ( A + B )}{{2}^{n + C}} ) & if x < 0\end{matrix} ; or$$
$$f ( x , n , A , B , C ) = \{ \begin{matrix}floor ( bitshift ( x , n ) ) & if x \geq 0 \\ - floor ( bitshift ( ( - x ) * A + B , n + C ) ) & if x < 0\end{matrix} ; or$$
$$f ( x , n , A , B , C ) = \{ \begin{matrix}bitshift ( x + {2}^{n - 1} , n ) & if x \geq 0 \\ - bitshift ( ( - x ) * A + B , n + C ) & if x < 0\end{matrix} ; or$$
$$f ( x , n , A , B , C , D ) = \{ \begin{matrix}bitshift ( x + D , n ) & if x \geq 0 \\ - bitshift ( ( - x ) * A + B , n + C ) & if x < 0\end{matrix} ; or$$
$$f ( x , A , B , C ) = \{ \begin{matrix}x & if x \geq 0 \\ - floor ( \frac{( - x ) * A + B}{{2}^{C}} ) & if x < 0\end{matrix} ; or$$
$$f ( x , A , B , C ) = \{ \begin{matrix}x & if x \geq 0 \\ - bitshift ( ( - x ) * A + B , C ) & if x < 0\end{matrix} ,$$
wherein bitshift(a1, a2) indicates a bit shifting operation corresponds to a bitwise shift operator, a2 is an integer,floor(a3) is equal to a largest integer less than or equal to a3,
wherein a division operation in the floor( ) operation is implemented using the bitwise shift operator, or a division operation in the floor( ) operation is replaced by a series of operations using at least one lookup table,
wherein constants A, B, and C are integer values that are determined in a way to approximate a regular leaky ReLU function, wherein in case that a negative slope of the regular leaky ReLU function is 0.01, A is set as round(2^{m}*0.01), B is set as 0 or 2^{m-1}, and C is set as m, wherein m is 13, or
wherein constants A, B, and C are selected in a way to approximate an arbitrary negative slope of the regular leaky ReLU function, which is a floating point number between 0 and 1 or between 0 and −1,
wherein the constant B has a value of zero when the bit shifting operation is a left shift operation, and wherein the constant B has a value greater than 0 when the bit shifting operation is a right shift operation, and
wherein D is an integer value and is equal to or greater than 0.

9. The method of claim 1, wherein the input is bit shifted by n bits in both a positive branch and in a negative branch, or
wherein additional layers are included between the convolution operation and the activation function;
wherein one of the additional layers is a cropping layer,
wherein each of the additional layers is a layer that does not include a device dependent operation which comprises at least one of: an operation using a floating point, a division operation, or a rounding operation, and
wherein a negative slope of the activation function is equal to zero, when an input of the activation function is an integer value, an output of the activation function is an integer value.

10. The method of claim 1, wherein a bit shifting operation is performed after the convolution operation and before the activation function.

11. The method of claim 1, wherein the convolution operation comprises one or more of: a multiplication with an integer value, a bit shifting operation, an addition with an integer value, and a clipping operation.

12. The method of claim 1, wherein one or more basic units is used to construct a neural subnetwork.

13. The method of claim 1, wherein a quantization operation is performed on an output of the activation function, and wherein the quantization operation uses only integers,
wherein a table, which comprises only integers, is used for the quantization operation, wherein the table comprises quantization levels and quantized output values, and
wherein the quantization operation comprises a mapping function between an integer input and an integer output.

14. The method of claim 1, wherein the convolution operation and the activation function are incorporated in a neural network based hyper scale decoder module,
wherein an output of the neural network based hyper scale decoder module comprises probability parameters, and
wherein one or more of the probability parameters comprise a standard deviation.

15. The method of claim 1, wherein a reconstructed image is obtained according to an output of the activation function, and
wherein the convolution operation and the activation function consist essentially of multiplication with integer values, bit-shifting operations, addition with integer values, clipping, and combinations thereof.

16. The method of claim 1, wherein the conversion includes encoding the visual media data into the bitstream.

17. The method of claim 1, wherein the conversion includes decoding the visual media data from the bitstream.

18. An apparatus for processing video or image data comprising:
a processor; and
a non-transitory memory with instructions thereon, wherein the instructions upon execution by the processor, cause the processor to:
apply a basic unit to perform a convolution operation on an input and to perform an activation function on an output of the convolution operation, wherein the convolution operation is performed using only integer values; and
perform a conversion between visual media data and a bitstream based on the convolution operation and the activation function.

19. A non-transitory computer readable storage medium storing instructions that cause a processor to:
apply a basic unit to perform a convolution operation on an input and to perform an activation function on an output of the convolution operation, wherein the convolution operation is performed using only integer values; and
perform a conversion between visual media data and a bitstream based on the convolution operation and the activation function.

20. A non-transitory computer-readable recording medium storing a bitstream of a video which is generated by a method performed by a video processing apparatus, wherein the method comprises:
applying a basic unit to perform a convolution operation on an input and to perform an activation function on an output of the convolution operation, wherein the convolution operation is performed using only integer values; and
generating a bitstream of visual media data based on the convolution operation and the activation function.
